(19) United States
(12) Patent Application Publication
(10) Pub. No.: US 2018/0156548 A1
(43) Pub. Date: Jun. 7, 2018

(54) PLATE HEAT EXCHANGER INTEGRATED WITH PIPELINE

(71) Applicant: S&G Co.,Ltd, Daejeon (KR)

(72) Inventor: Jung Hoon YOON, Daejeon (KR)

(73) Assignee: S&G Co.,Ltd, Daejeon (KR)

(21) Appl. No.: 15/369,050

(22) Filed: Dec. 5, 2016

(51) Int. Cl. F28F 3/12; F28F 9/02; F28F 21/06; B60K 11/02

(52) U.S. Cl. CPC F28F 3/12; F28F 9/0243; F28F 21/067; B60Y 2400/112; F28F 2265/16; B60Y 2200/91; B60K 11/02

(57) ABSTRACT

Provided is a technology for a battery module used in an electric vehicle, and, more particularly, a plate heat exchanger integrated with pipelines, the heat exchanger which has a structure as simple as possible and thus is able to streamline a manufacturing process, reduce manufacturing price, and maximize heat exchange effects due to pipelines formed on a pipeline plate which is formed on an inner surface of the plate heat exchanger.

### TECHNICAL FIELD

The present invention relates to a battery module used in an electric vehicle, and, more particularly, to a plate heat exchanger integrated with pipelines, the heat exchanger which has a simple structure, thereby making a manufacturing process simple and reducing manufacturing costs.

More specifically, the present invention relates to a technology for a plate heat exchanger integrated with pipeline, the plate heat exchanger which is made by installing cover plates onto both surfaces of a pipeline plate having pipelines formed thereon, so that simple structure may be achieved and a manufacturing process may be streamlined.

### BACKGROUND ART

In general, a vehicle runs on gasoline or diesel, and an engine inside the vehicle burns the fuel to generate power by which the vehicle is able to travel along a roadway or carries loads. As air pollution has gained increasing attention in recent years, many restrictions and regulations have been provided to curb carbon dioxide emission, and accordingly, efforts are being made to develop a vehicle which does not discharge carbon dioxide and utilizes clean fuel.

In light of this, recently developed electric vehicles run on electricity generated by a battery, not gasoline or diesel, thus enabled to reduce air pollution without discharging carbonate oxide. These days, to overcome its limited capacity and reduce the size, the battery for the electric vehicle is manufactured as a module which is a collection of multiple cell unit batteries.

Because the recent battery module supplies power to a high-power actuating motor, large amounts of heat are generated when the battery module is charged or discharged. The high-temperature heat may deteriorate the battery cell, and, for this reason, it is required to develop a battery module having a structure for cooling down the battery cell to improve heat dissipation properties.

In addition, a lithium ion battery has great resistance at low temperature and thus its performance or function, such as cold cranking, may be degraded. Therefore, there is need for a technology for not just cooling down a battery cell, but increasing temperature of the battery so as to enable the cold cranking function.

As a conventional art of cooling down a battery cell of an electric vehicle, Korean Laid-open Patent Publication No. 10-2013-0091211 (titled “Heat Dissipation Plate for Battery Cell Module and Battery Cell Module Having the Same”) has been proposed.

The conventional art relates to a heat dissipation plate inserted between battery cells, and the plate includes: composite sheets in which a heat-conductive filler is filled in a matrix resin; and carbon fibers inserted between the composite sheets, wherein the carbon fibers are inserted in the composite sheets to extend to an edge portion of the heat dissipation plate.

This conventional art is about an air cooling-down technology which introduces a cool air to the battery cells and the heat dissipation plate to dissipate the heat accumulated in the battery cell and the module to the outside. The size of the module may be reduced because the heat dissipation plate having the carbon fibers are inserted between the battery cells. However, it may reduce heat exchange efficiency of the heat dissipation plate, lessening heat dissipation effects.

In addition, as a conventional art of cooling down a battery cell, there is a cooling device using a heat medium (coolant), and this cooling device employs a plate heat exchanger in which cooling pipes are jointed to an aluminum plate by brazing or by a mechanical joint.

In such a plate heat exchanger, a heat bottleneck phenomenon occurs at the joint areas of the cooling pipes, and this reduces heat exchange efficiency. In addition, the manufacturing process is complicated, decreasing productivity and economic efficiency. Meanwhile, due to the increase in temperature during the brazing process, mechanical properties of the plate heat exchanger and the cooling pipes are changed, thereby compromising durability and air-tightness.

### RELATED ART DOCUMENT

### Patent Document

(Patent Document 1) Korean Patent No. 10-1029353

(Patent Document 2) Korean Patent No. 10-1093959

(Patent Document 3) Korean Patent No. 10-1252963

(Patent Document 4) Korean Patent No. 10-1271858

### DISCLOSURE

### Technical Problem

The present invention is developed to solve the problems of the conventional technology of cooling down a battery cell, the problem including: heat dissipation properties deteriorated by reduced heat exchange efficiency; productivity and economic efficiency which are decreased by complicated manufacturing process, and less durability and air-tightness. The present invention aims to provide a plate heat exchanger integrated with pipelines, the heat exchanger which includes pipelines integrally formed with a pipeline plate, and cover pouches installed onto the both surfaces of the pipeline plate, so that the pipelines are integrated into the pipeline plate. This structure prevents a heat bottleneck phenomenon, thereby increasing heat exchange efficiency, streamlining a manufacturing process to increase productivity and economic efficiency, reducing the size of a module, and achieving a lightweight structure.

### Technical Solution

To achieve the above object, a plate heat exchanger integrated with pipelines according to the present invention includes: a pipeline plate which comprises a plate part which is in a form of a flat plate and on which a plurality of pipelines are formed, and a head part having a pipeline which is formed at one end or both ends of the plate part 11 and through which a refrigerant is supplied or discharged; and cover pouches installed on both surfaces of the pipeline plate so as to prevent the refrigerant from leaking from open surfaces of pipelines.

The pipelines may be in the form of holes which penetrate the plate part or may be in the form of grooves formed on both surfaces of the plate part.

A partition-type branch may be formed at the center of the head part; a refrigerant inflow portion, through which a refrigerant inflows, may be formed at one end of the head part; a refrigerant discharge portion, through which the refrigerant passing through a pipeline groove is discharged, may be formed at the other end of the head part; and refrigerant inflow holes and refrigerant discharge holes may be formed at locations corresponding to the pipelines formed on the plate part.

Pouch fixing grooves may be formed between the pipelines of the plate part and formed on a circumferential surface of the head part 12 so as to strongly fix the cover pouches.

A gentle slope may be formed between the plate part and the head part of the pipeline plate.

The cover pouches may be made of a thermoplastic material so that the cover pouches are easily thermally adhered to the pipeline plate.

A heat transfer plate may be further installed in the outside of the cover pouches, the heat transfer plate in which a head cover covering the head part is integrally formed with one side of a board covering the plate part, thereby improving heat transfer efficiency and easily fixing a battery cell.

### Advantageous Effects

A plate heat exchanger integrated with pipelines according to the present invention has pipelines which are formed on a plate surface of the plate heat exchanger for cooling down and heating a battery cell and through which a heat medium (coolant, hot water) passes, thereby increasing heat exchange efficiency.

In addition, due to the structure in which a pouch is thermally adhered to pipelines and a pipeline plate which are integrally molded, it is possible to achieve a simple structure of the plate heat exchanger and streamline a manufacturing process, thereby reducing manufacturing costs.

In particular, it is possible to easily form flow passages using a pouch which is adhered to the inner surface of the plate heat exchanger, in other words, which is adhered to the pipeline plate at an area in contact with a heat exchanging plate.

### DESCRIPTION OF DRAWINGS

FIG. 1 is a perspective view illustrating an example of a plate heat exchanger according to the present invention.

FIG. 2 is a plan view illustrating an example of a plate heat exchanger according to the present invention.

FIG. 3 is a cross-sectional view taken along the line A-A shown in FIG. 2.

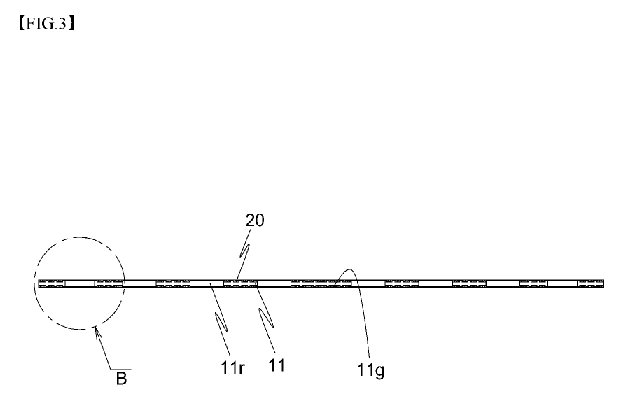

FIG. 4 is enlarged details of an area B shown in FIG. 3.

FIG. 5 is a front view illustrating the plate heat exchanger, shown in FIG. 2, seen from a head part.

FIG. 6 is enlarged details of an area C shown in FIG. 5.

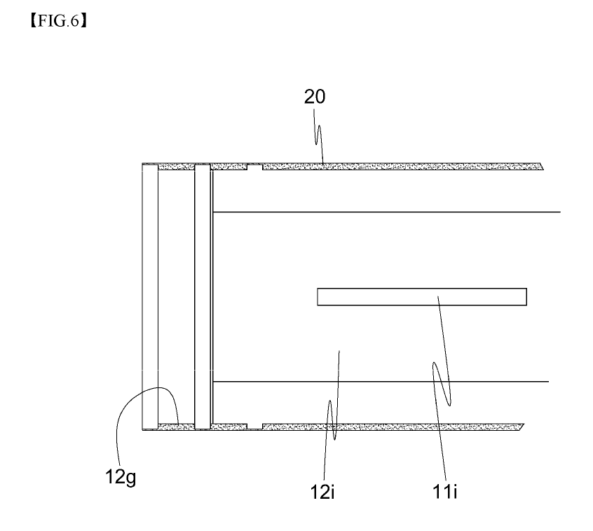

FIG. 7 is a perspective view illustrating another example of a plate heat exchanger according to the present invention.

FIG. 8 is a side view illustrating another example of a head part of the plate heat exchanger according to the present invention.

FIG. 9 is a perspective view illustrating yet another example of a plate heat exchanger according to the present invention.

FIG. 10 is a cross-sectional view of the plate heat exchanger shown in FIG. 9.

FIG. 11 is enlarged details of an area D shown in FIG. 10.

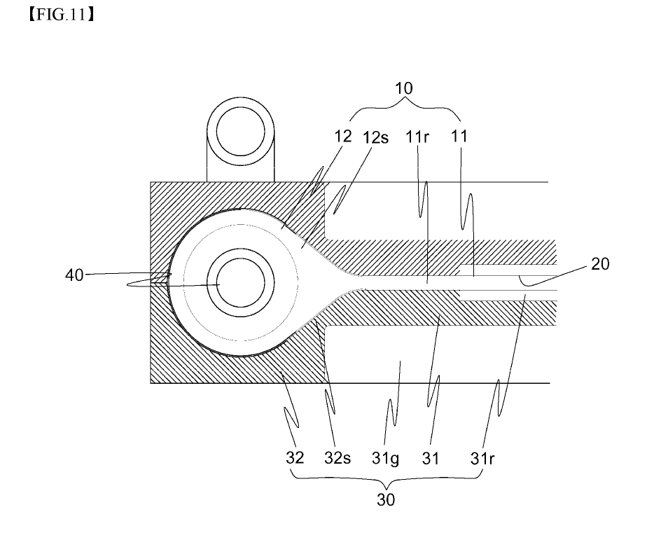

FIG. 12 is a perspective view illustrating an example of a heat transfer plate included in the plate heat exchanger shown in FIG. 9.

FIG. 13 is a bottom perspective view an example of a heat transfer plate included in the plate heat exchanger shown in FIG. 9.

### BEST MODE

Various modification and embodiments are possible for the present invention, and merely particular embodiments are shown in the drawings and described in the detailed descriptions. However, it is to be understood that the present invention is not limited to the particular embodiments and shall be construed as including all permutations, equivalents and substitutes covered by the ideas and scope of the present invention.

For descriptions of each drawing, similar elements are denoted by the same reference numerals even though they are depicted in different drawings and redundant descriptions thereof will be omitted. In the following description of the embodiments disclosed in the present specification, a detailed description of known functions and configurations incorporated herein will be omitted when it may make the subject matter of the embodiments disclosed in the present specification rather unclear.

Hereinafter, referring to the accompanying drawings, the primary configurations of an embodiment of the present invention include a pipeline plate 10 on which pipelines 11r are formed, and a cover pouch 20 which covers open surfaces of pipelines formed on the pipeline plate. A refrigerant (coolant, hot water) passes through the pipelines 11r.

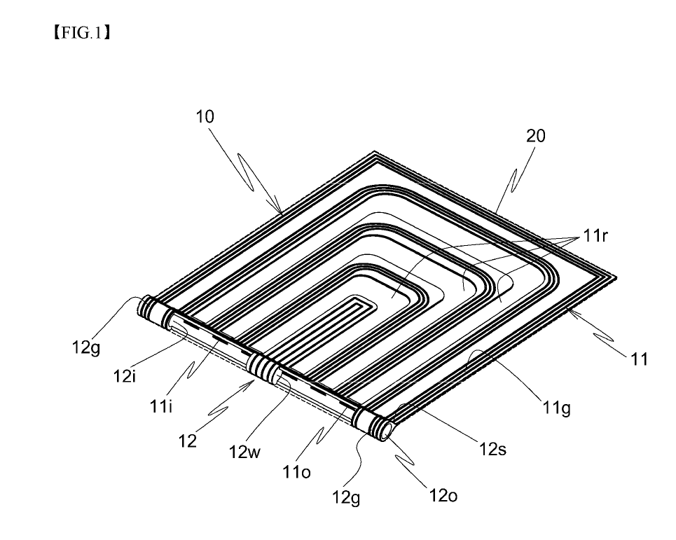

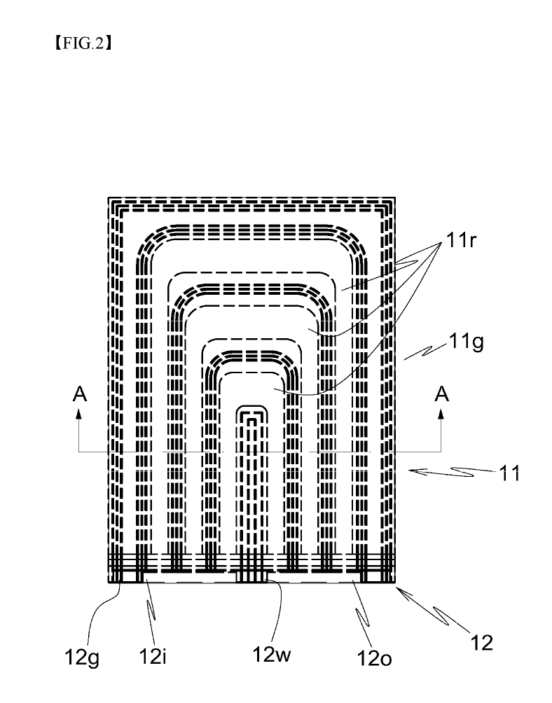

As illustrated in FIGS. 1, 2, and 7, the pipeline plate 10 includes: a plate part 11 which is in the form of a flat plate and on which a plurality of pipelines 11r are formed; and a head part 12 having a pipeline which is formed at one end or both ends of the plate part 11 to supply or discharge the refrigerant through the pipeline.

As illustrated in the drawings, there are provided a plurality of pipelines 11r. A pouch bonding adhesive to which the cover pouch is adhered is formed between the pipelines 11r. A plurality of pouch fixing grooves 11g are formed in the pouch bonding adhesive, and part of the cover pouch 20 is inserted into the pouch fixing grooves 11g.

That is, the cover pouch 20 is made of a thermoplastic material to be easily thermally adhered to the pipeline plate 10. When the cover pouch 20 is disposed to cover the surface of the pipeline plate and then pressed by heat, the cover pouch 20 is adhered to the surface of the pipeline plate 10 and thus covers the open surfaces of the pipelines 11r to form flow passages.

In the above heat fusion process for the cover pouch 20, part of the cover pouch is press-fitted into the pouch fixing groove 11g to be integrated with the pipeline plates 10.

Of course, a pouch fixing groove 12g may be formed on the circumferential surface of the head part 12 of the pipeline plate 10, and part of the cover pouch 20 may be fitted into the cover pouch 20.

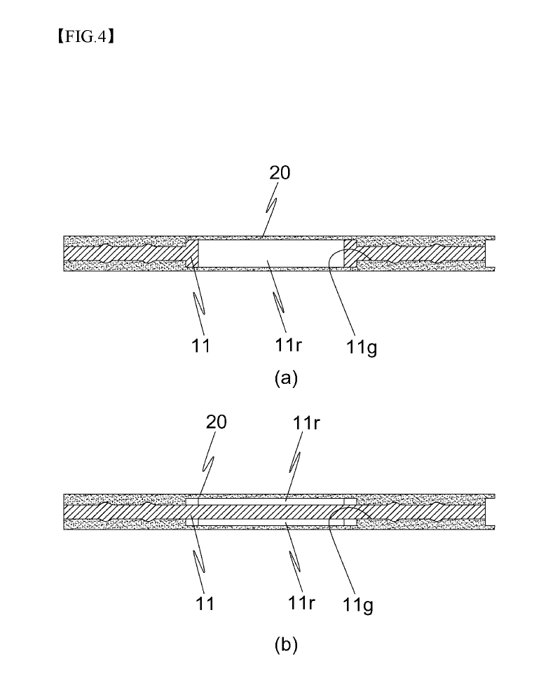

The pipelines 11r formed on the pipeline plate 10 may be in the form of holes, as shown in FIG. 4(a), which penetrate the plate part 11, or may be grooves formed on the both surfaces of the plate part 11.

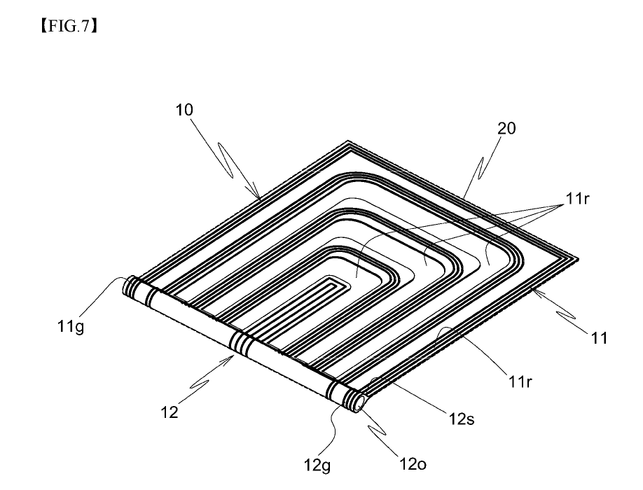

In addition, the head part 12 of the pipeline plate 10 may be in a cylindrical shape, as shown in FIG. 7, and refrigerant inflow holes and refrigerant discharge holes may be formed on a side wall of the head part 12 so as to be connected to the pipelines 11r formed on the plate part 11.

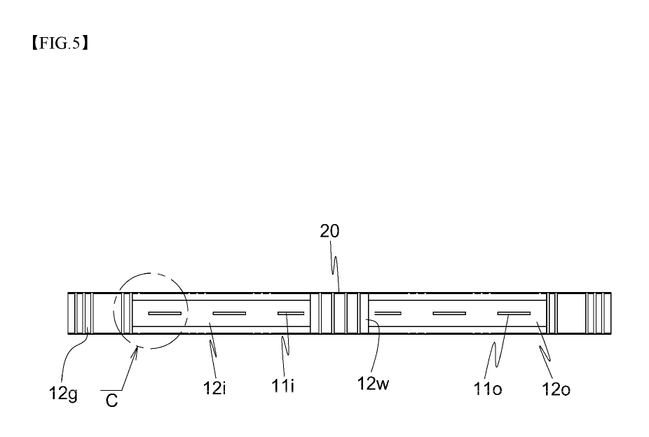

In another embodiment, as shown in FIGS. 1, 2, and 5, the head part 12 may be in a cylindrical shape, and include a partition-type branch 12w at the center of the head part 12, a refrigerant inflow portion 12i which is formed at one end of the head part 12 and through which refrigerant inflows, and a refrigerant discharge portion which is formed at the other end of the head part 12 and through which refrigerant passing through the pipeline groove are discharged.

That is, the refrigerant inflow portion 12i and the refrigerant discharge portion 12o are respectively formed at the two ends of the head part 12 with the branch 12w between them. Accordingly, a refrigerant flowed into the refrigerant inflow portion 12i may pass through the pipeline groove and then be discharged through the refrigerant discharge portion 12o.

In addition, semi-circular shaped pipeline grooves are formed on a surface, facing the plate part, between the branch 12w and the refrigerant inflow portion 12i of the head part 12 and between the branch 12w and the refrigerant discharge portion 12o. Refrigerant inflow holes 11i and refrigerant discharge hole 11o are formed on the side wall of the pipeline groove at locations corresponding to the pipelines 11r formed on the plate part 10.

Accordingly, a refrigerant flowed into the pipeline groove between the branch 12w and the refrigerant inflow portion 12i flows into the pipeline 11r through a plurality of refrigerant inflow holes 11i and are discharged to a plurality of refrigerant discharge holes 11o formed on the pipeline groove between the branch 12w and the refrigerant inflow portion 12i, thereby making the flow of the refrigerant smoothly.

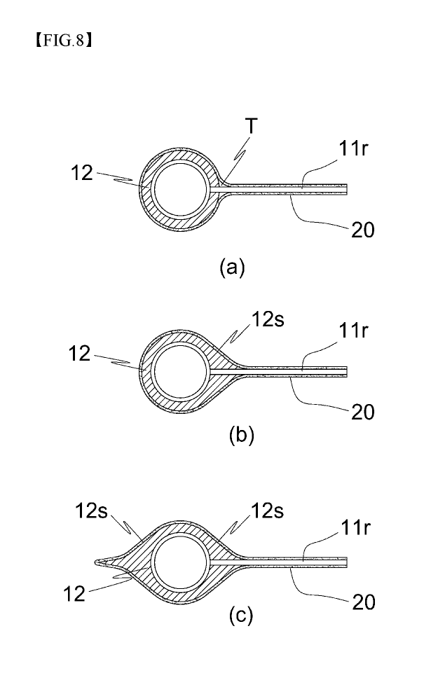

In addition, if a joint area between the plate part 11 and the head part 12 of the pipeline plate 10 form an angle as shown in FIG. 8(a), the angle between the plate part 11 and the head part 12 of the pipeline plate 10 may be so sharp that the cover pouch 20 disposed in the outside may not be attached to the joint area and therefore there may be a gap T which could lead to leakage.

For this reason, as shown in FIGS. 8(b) and 8(c), it is desirable to form a gentle slope 12S between the plate part 11 and the head part 12 of the pipeline plate 10 so as to allow the cover pouch 20 to be strongly attached thereto.

As described above, it is desirable that the cover pouch 20 is made of a thermoplastic material to be easily thermally adhered to the pipeline plate 10, and that the cover pouch 20 employs a multiple-layer film to reinforce strength.

Examples of the cover pouch 20 include a three-layer film comprising layers of PET, Al, and PE or PP, or a four layer film comprising layers of PET, Al, nylon, and thermal resin such as PE or PP.

Having the above configuration, the plate heat exchanger integrated with pipelines according to the present invention is manufactured by covering a surface of the pipeline plate 10 by the film-type cover pouch 20, so the simple structure may be achieved and productivity may increase due to a simple manufacturing process.

The plate heat exchanger integrated with pipelines according to the present invention has the above-described advantages, but the structure may be weak. Thus, it is desirable to install an additional reinforcement means in the outside.

As the reinforcement means, a heat transfer plate 30 may be further installed in the outside of the cover pouches 20, the heat transfer plate 30 in which a head cover 32 covering the head part 12 is integrally formed with one side of a board 31 covering the plate part 11.

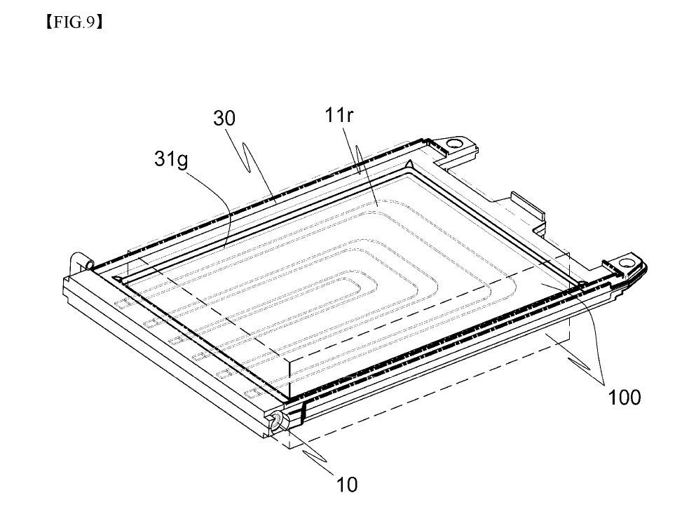

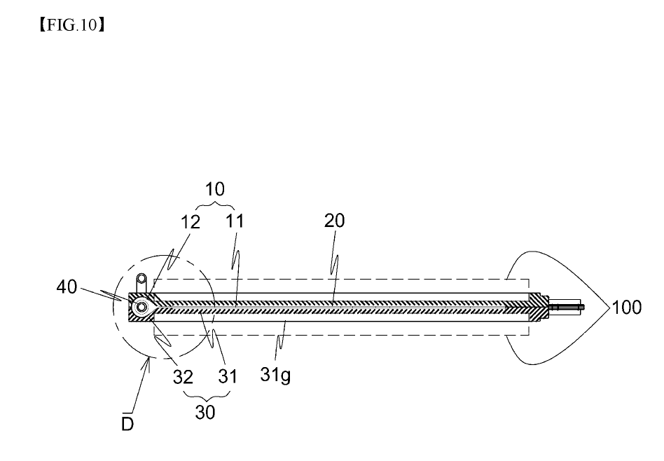

For thermal conductivity and lightweight, the heat transfer plate 30 is desirably made of aluminum or an aluminum alloy which is lightweight. As shown in FIGS. 9 and 10, the heat transfer plate 30 is a rectangular panel which is large enough to allow a battery cell 100 to be attached thereto.

As described above, the heat transfer plate 30 is a means used to protect the cover pouch 20 laminated onto the surface of the pipeline plate 10, to efficiently transfer heat or cool air of a refrigerant flowing along pipelines of the pipeline plate, and to allow a battery cell to be easily installed onto the plate heat exchanger.

The heat transfer plate 30 directly contacts the battery cell 100 so as to absorb heat of the battery cell or transfer heat to the battery cell, and a cell rest groove 31g is formed, as shown in FIGS. 9 and 10, to fix the battery cell 100 stably.

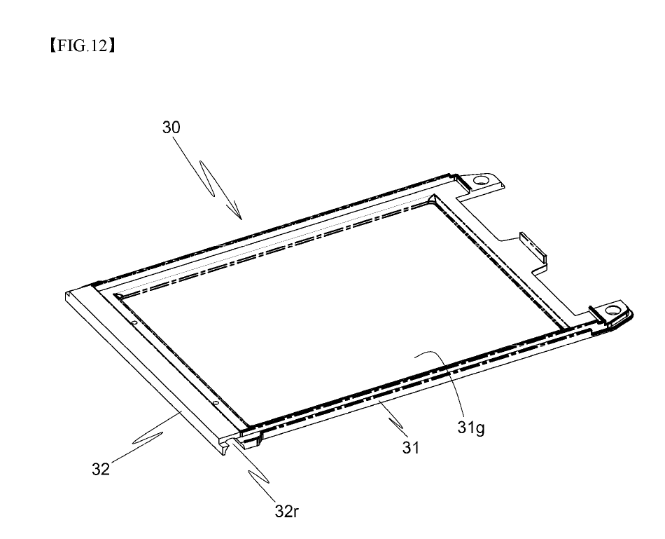

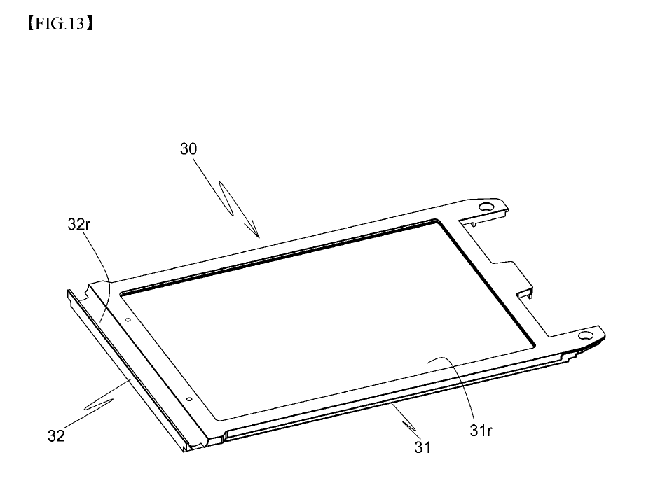

As shown in FIGS. 12 and 13, the heat transfer plate 30 includes: the board 31 in which the plate part 11 of the pipeline plate 10 rests: and a head cover 32 which is integrated with the board 31 such that the head cover 32 is formed on one side of the board 31 to cover the head part 12.

That is, as shown in FIGS. 12 and 13, the cell rest groove 31g in which the battery cell 100 rests is formed on the outer surface of the board 31 of the heat transfer plate 30, and a plate part rest groove 31r is formed on the inner surface thereof, and a semi-circular head rest groove 32r having the same shape as the external appearance of the head part is formed on a surface facing the head part of the head cover 32.

The heat transfer plate 30 consists of two plates which are installed on the front and rear surfaces of the pipeline plate such that the two plates are assembled by a fixing means, such as a fixing screw, to encompass the pipeline plate being disposed between the two plates.

Of course, a slope 32s is formed at a location corresponding to the slope 12s formed on the pipeline plate 10, and the slope 32s is in contact with the slope 12s.

In the drawings, reference numeral 40 indicates a refrigerant supply pipe installed at the refrigerant inflow portion 12i.

Preferred embodiments of the present invention are described in the above, but the scope of the invention is not limited to the aforementioned embodiments, and it will be understood by those skilled in the art that various modifications may be made without departing from the spirit and scope of the invention as defined by the appended claims.

### EXPLANATION OF REFERENCE NUMERALS

| | |
|---|---|
| 10: Pipeline plate | |
| 11: Plate part | 11i: Refrigerant inflow hole |
| 11o: Refrigerant discharge hole | 11r: Pipeline |
| 11g: Cover fixing groove | |
| 12: Head part | 12g: Pouch fixing groove |
| 12s: Slope | 12w: Branch |
| 12i: Refrigerant inflow portion | 12o: Refrigerant discharge portion |
| 20: Cover pouch | |
| 30: Heat transfer plate | |
| 31: Board | 31r: Pipeline plate rest groove |
| 31g: Cell rest groove | 32: Head cover |
| 32s: Slope | |
| 40: Refrigerant supply pipe | |

1. A plate heat exchanger integrated with pipelines, comprising:
a pipeline plate which comprises a plate part which is in a form of a flat plate and on which a plurality of pipelines are formed, and a head part having a pipeline which is formed at one end or both ends of the plate part and through which a refrigerant is supplied or discharged; and
cover pouches installed on both surfaces of the pipeline plate so as to prevent the refrigerant from leaking from open surfaces of pipelines.

2. The plate heat exchanger of claim 1, wherein the pipelines are in the form of holes which penetrate the plate part.

3. The plate heat exchanger of claim 1, wherein the pipelines are in the form of grooves on the both surfaces of the plate part.

4. The plate heat exchanger of claim 1,
wherein:
a partition-type branch is formed at the center of the head part;
a refrigerant inflow portion, through which a refrigerant inflows, is formed at one end of the head part;
a refrigerant discharge portion, through which the refrigerant passing through a pipeline groove is discharged, is formed at the other end of the head part; and
refrigerant inflow holes and refrigerant discharge holes are formed at locations corresponding to the pipelines of the plate part.

5. The plate heat exchanger of claim 4, wherein pouch fixing grooves are formed between the pipelines of the plate part and formed on a circumferential surface of the head part so as to strongly fix the cover pouches.

6. The plate heat exchanger of claim 5, wherein a gentle slope is formed between the plate part and the head part of the pipeline plate.

7. The plate heat exchanger of claim 6, wherein the cover pouches are made of a thermoplastic material to be easily thermally adhered to the pipeline plate.

8. The plate heat exchanger of claim 7, wherein a heat transfer plate is further installed in the outside of the cover pouches, the heat transfer plate in which a head cover covering the head part is integrally formed with one side of a board covering the plate part.

9. The plate heat exchanger of claim 8, wherein a cell rest groove in which a battery cell rests is formed on an outer surface of the board of the heat transfer plate.
